(19) United States
(12) Patent Application Publication
(10) Pub. No.: US 2017/0196401 A1
(43) Pub. Date: Jul. 13, 2017

(54) Toasting Apparatus

(71) Applicant: Ian Chun Kong CHEUNG, Hong Kong (CN)

(72) Inventor: Ian Chun Kong CHEUNG, Hong Kong (CN)

(21) Appl. No.: 15/320,772

(22) PCT Filed: Jul. 20, 2015
(86) PCT No.: PCT/CN2015/084449

§ 371 Date: Dec. 21, 2016

(30) Foreign Application Priority Data
Jul. 21, 2014 (HK) 14107431.6

(51) Int. Cl. A47J 37/08

(52) U.S. Cl. CPC A47J 37/08

(57) ABSTRACT

A toasting apparatus has a toasting space for receiving a food item, electrical heaters for toasting the food item, a temperature sensor for sensing the temperature of the toasting space and providing an output signal, and a control circuit for controlling the heaters in a toasting operation by reference to an output signal of the temperature sensor corresponding to an initial temperature associated with the toasting space immediately prior to commencement of the toasting operation. The control circuit controls the heaters by varying the operating power and/or time of the heaters during each toasting operation in an inverse relationship to the initial temperature.

The present invention generally relates to toasting apparatus and more particularly, but not exclusively, to toasting apparatus for toasting bread products such as, but not limited to, pizza breads supported on a spit.

### BACKGROUND OF THE INVENTION

Toasting/cooking apparatus, such as those for toasting or baking bread products, are becoming ever increasingly popular. It is important to control the cooking or toasting temperature and time in order to obtain optimum toasting quality for the products, especially for toasting small items of food when the temperature of the toasting space in the toasting apparatus varies between toasting operations by reason of the uncertainty in the period of time for which the toasting apparatus has been left idle from the last toasting operation.

The present invention seeks to mitigate or at least to alleviate such a problem by providing new or otherwise improved toasting apparatus.

### SUMMARY OF THE INVENTION

According to the invention, there is provided toasting apparatus which comprises a body having a toasting space for receiving an item of food to be toasted, at least one electrical heating element associated with the body for toasting a said item of food, a temperature sensor for sensing temperature associated with the toasting space and providing an output signal indicative of the sensed temperature, and a control circuit adapted to control the operation of said at least one heating element in a toasting operation by reference to an output signal of the temperature sensor corresponding to an initial temperature associated with the toasting space immediately prior to commencement of the toasting operation. The control circuit is adapted to control the operation of said at least one heating element by varying at least one of operating power and operating time of said at least one heating element during each toasting operation in an inverse relationship with respect to the initial temperature.

Preferably, the control circuit is adapted to control the operation of said at least one heating element by varying the operating time of said at least one heating element.

Preferably, the control circuit is adapted to control the operation of said at least one heating element by varying the mark-to-space ratio in terms of operation of said at least one heating element.

More preferably, the control circuit is adapted to control the operation of said at least one heating element by varying the relative time of turning on and turning off of said at least one heating element.

It is preferred that the time of turning on of said at least one heating element is determined by the control circuit based on the aforesaid initial temperature in an inverse relationship.

It is preferred that the control circuit is adapted to control the operation of said at least one heating element by initially not turning on and subsequently upon elapsing of a certain time interval turning on said at least one heating element, the time interval being determined by the control circuit based on the aforesaid initial temperature in a direct relationship.

It is preferred that the control circuit is adapted to control the operation of said at least one heating element by delaying turning on of said at least one heating element by a certain time interval which is determined by the control circuit based on the aforesaid initial temperature in a direct relationship.

It is further preferred that the aforesaid relationship comprises a generally linear relationship.

Preferably, the control circuit is adapted to turn on and turn off said at least one heating element in one or more cycles during each toasting operation.

Preferably, the times of turning on and turning off of said at least one heating element during each toasting operation add up to a total period of time which is practically constant over a possible range of the aforesaid initial temperature.

Preferably, the times of turning on and turning off of said at least one heating element during each toasting operation add up to a total time period which falls within a predetermined range within 10% plus-or-minus variation over a possible range of the aforesaid initial temperature.

In a preferred embodiment, the body comprises a base and an upper module provided on or above the base and supported for movement between a toasting position in which the upper module is closed upon the base, together defining the toasting space, and a non-toasting position in which the upper module is opened from the base, and wherein a first said heating element is provided at the base for toasting a lower side of a said item of food, a second said heating element is provided at the upper module for toasting an upper side of a said item of food, and the temperature sensor is provided at the base.

More preferably, the control circuit operatively controls the operation of both the first and the second heating elements.

Further more preferably, the control circuit operatively controls the operation of the first and second heating elements in respective (different) inverse relationships with respect to the aforesaid initial temperature.

It is preferred that the second heating element comprises an infrared heating element.

It is preferred that the upper module includes two said second heating elements, which are provided on or within opposite left and right sides of a ceiling of the upper module.

It is further preferred that the two second heating elements are spaced apart as between opposite left and right sides of the ceiling and are located to face inwards at an acute angle.

In a preferred embodiment, the control circuit is adapted to commence each toasting operation upon movement of the upper module to the toasting position and to terminate each toasting operation with movement of the upper module from the toasting position.

More preferably, the control circuit includes an electrical switch having an operating member which is arranged for movement to close the electrical switch to commence each toasting operation in response to the upper module reaching the toasting position and for movement to open the electrical switch to terminate the toasting operation in response to the upper module departing from the toasting position.

Further more preferably, the upper module is resiliently biased towards the non-toasting position, and the control circuit includes an electromagnetic catch arranged to hold the upper module in the toasting position during each toasting operation and to release the upper module from the toasting position upon termination of the toasting operation.

In a preferred construction, the upper module has a housing with a skirt which in the toasting position closes upon the base and defines a periphery of the toasting space.

More preferably, the housing of the upper module has solid walls and an open bottom side defining the skirt, the housing being capable of trapping hot air.

It is preferred that the base includes a platform which is of a matching shape but a slightly smaller size relative to the skirt and is arranged in the toasting position to be at least partially surrounded by the skirt.

In a preferred embodiment, the toasting space is provided with at least one guide for guiding and positioning a said item of food in the toasting space.

In a preferred embodiment, the toasting space is provided with at least one guide for guiding and positioning a said item of food in the toasting space, said at least one guide comprising a recess for receiving and positioning an elongate member holding a said item of food.

More preferably, said at least one guide comprises two said recesses at opposite ends of the toasting space for receiving and positioning respective opposite ends of the elongate member holding a said item of food.

Further more preferably, one of the recesses is provided centrally on the base and the other recess is provided centrally on the upper module.

In a preferred embodiment, the body comprises one said base and a plurality of said upper modules, each upper module including a respective said second heating element and being provided on or above a respective base portion of the base to define a respective said toasting space, with each base portion including a respective said first heating element.

### BRIEF DESCRIPTION OF DRAWINGS

The invention will now be more particularly described, by way of example only, with reference to the accompanying drawings, in which:

FIG. 1 is a front and left side perspective view of an embodiment of toasting apparatus in accordance with the invention, having a base and three upper modules on the base;

FIG. 2 is a left side view of the toasting apparatus of FIG. 1, with an upper module thereof in an open position;

FIG. 3 is a left side view corresponding to FIG. 2, showing the upper module in a closed position;

FIG. 4 is a perspective view of the toasting apparatus corresponding to FIG. 1, with an upper module thereof opened and a portion thereof cut open to reveal certain inside parts;

FIG. 4A is enlarged perspective view of the cut-open portion of FIG. 4;

FIG. 5 is a perspective view of the toasting apparatus corresponding to FIG. 1, with an upper module thereof closed and a portion thereof cut open to reveal certain inside parts;

FIG. 5A is enlarged perspective view of the cut-open portion of FIG. 5;

FIG. 6 is a perspective view of the toasting apparatus corresponding to FIG. 1, with an upper module thereof disassembled and a portion thereof cut open to reveal certain inside parts;

FIG. 6A is enlarged perspective view of the cut-open portion of FIG. 5;

FIG. 7 is a perspective view of the toasting apparatus corresponding to FIG. 1, with an upper module thereof opened and a portion thereof cut open to reveal certain inside parts;

FIG. 7A is enlarged perspective view of the cut-open portion of FIG. 7;

FIG. 8 is a left side view of the toasting apparatus of FIG. 2, with the upper module in an open position, depicted see-through to show certain internal parts;

FIG. 9 is a left side view of the toasting apparatus of FIG. 2, with the upper module in a closed position, depicted see-through to show certain internal parts;

FIG. 10 is a front view of the toasting apparatus of FIG. 9;

FIG. 11 is a schematic circuit diagram of a control circuit of the toasting apparatus of FIG. 1;

FIG. 12 is a diagram of waveforms for control of heaters versus temperature for the toasting apparatus of FIG. 1;

FIG. 13 is a graphical representation of relationship of heaters ON time expressed as percentage versus temperature for the toasting apparatus of FIG. 1;

FIG. 14 is a graphical representation corresponding to FIG. 13, showing relationship of heaters OFF time expressed as percentage versus temperature for the toasting apparatus of FIG. 1; and

FIGS. 15 to 17 are views of a pizza bread for toasting by the toasting apparatus of FIG. 1.

### DETAILED DESCRIPTION OF PREFERRED EMBODIMENT

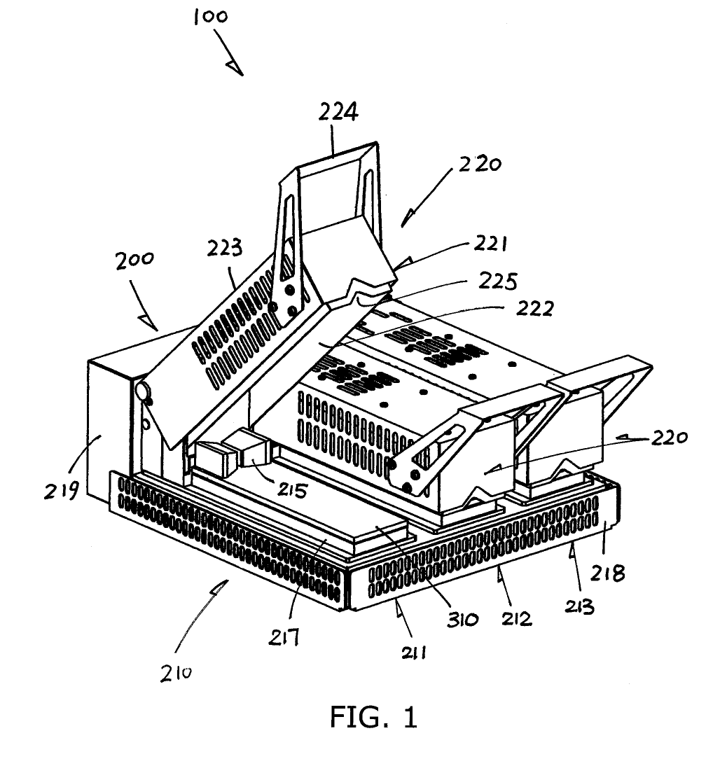

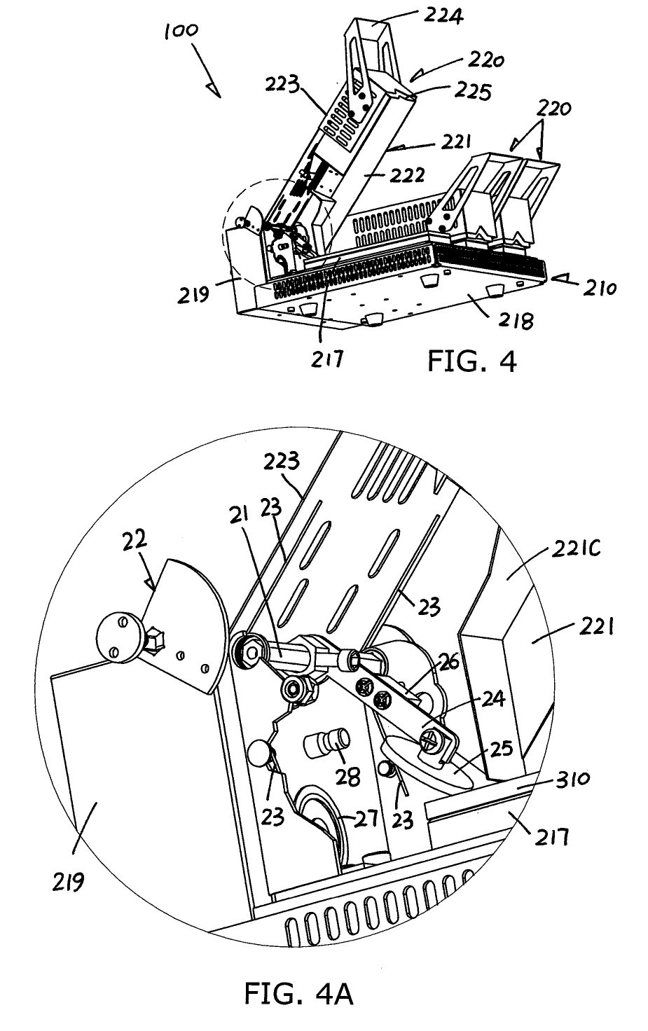

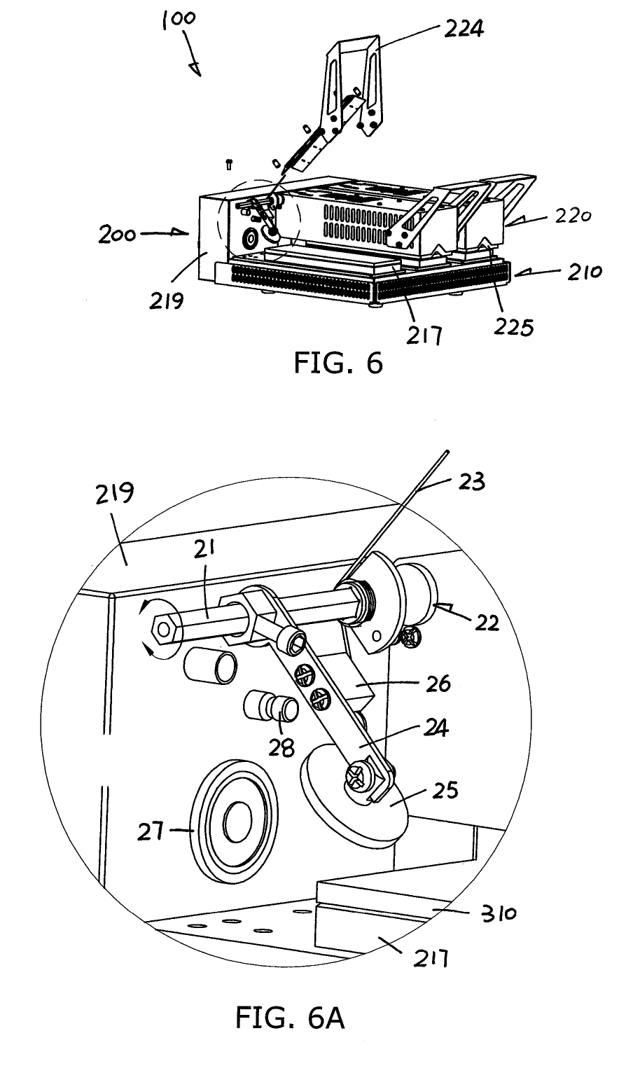

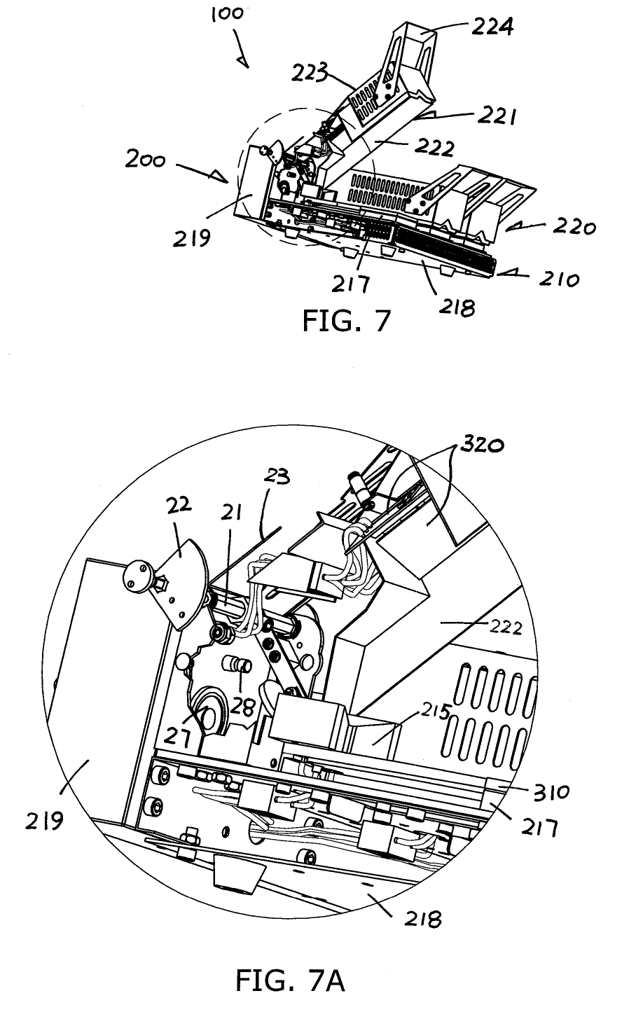

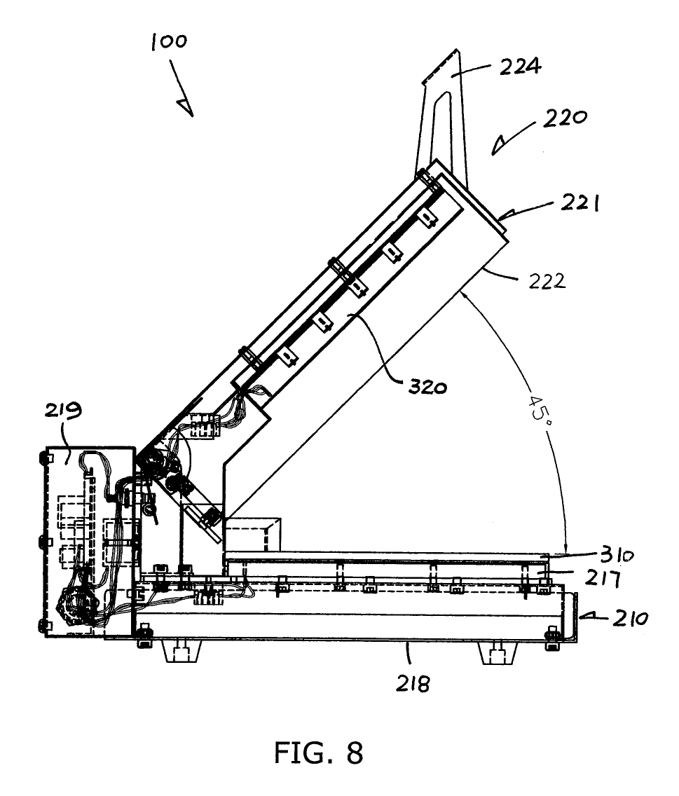

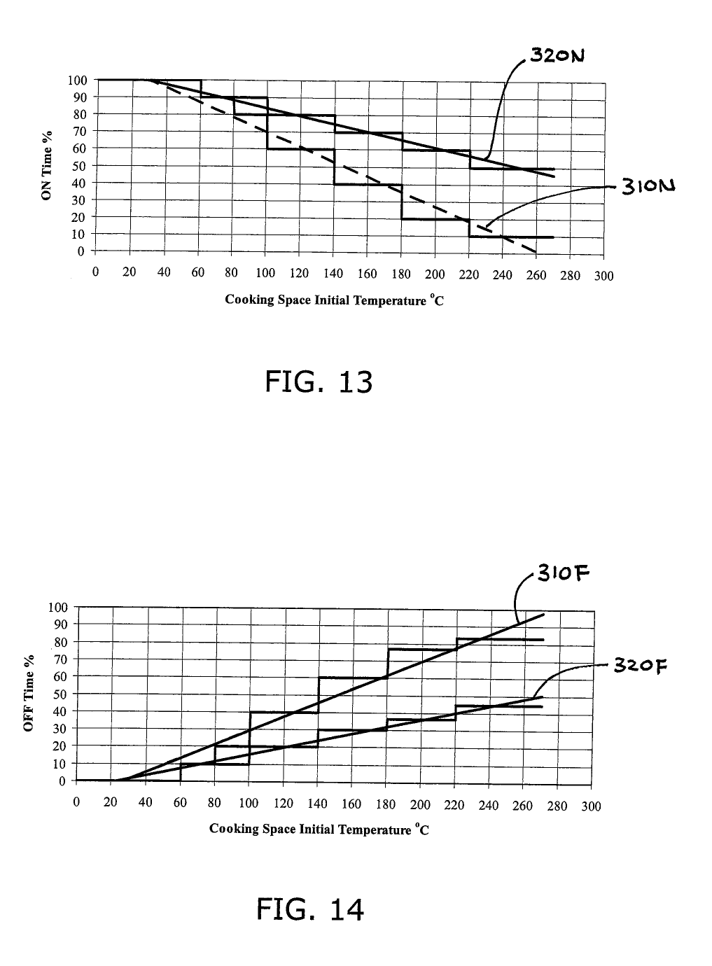

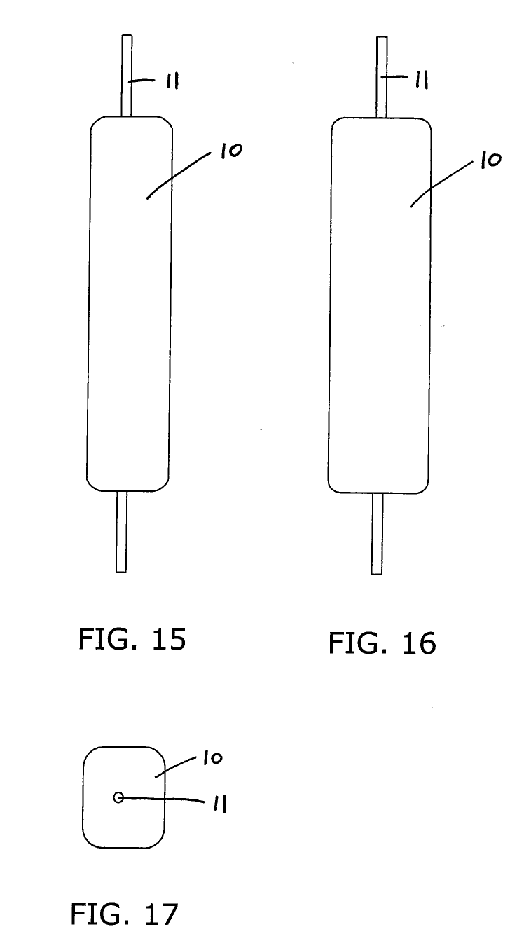

Referring to FIGS. 1 to 17 of the drawings, there is shown toasting apparatus 100 embodying the invention, which is for toasting items of food and for example in particular pizza breads 10 by using dry heat from an electrical heat source. Different types of bread/dough materials and different sizes of the food products require different toasting temperatures and times. This particular toasting apparatus 100 is designed to toast pizza breads 10 of a specific oblong rectangular shape as shown in FIGS. 14 to 16, through which a central spit 11, e.g. a bamboo stick, pierces through for convenient handling. The pizza breads 10 are originally prepared or available in a cooked and substantially cooked condition, either at room temperature or chilled if not frozen, covered with toppings from a large variety of choices as is known for conventional pizzas.

Broadly stated, the toasting apparatus 100 has a body 200 providing a toasting space for an item of food, at least one electrical heating element or heater 300—three sets of first and second heaters 310 and 320 in this particular embodiment—for toasting the food item, a temperature sensor 400 for sensing temperature associated with the toasting space, and a control circuit 500 adapted to control the operation of the heater(s) 300 in a toasting operation by reference to the initial temperature sensed by the temperature sensor 400 immediately prior to commencement of the toasting operation. Such an initial temperature may be the room temperature or a higher, residue temperature left behind from the last toasting operation.

The control circuit 500 controls the operation of the heater 300 by varying at least one of operating power and operating time of the heater 300 during each toasting operation in an inverse relationship with respect to the aforesaid initial temperature. Hence, as the initial temperature increases (or decreases), the heater's operating power and/or time decreases (or increases).

The body 200 of the toasting apparatus 100 has a horizontal base 210 which is divided into three left, middle and right portions 211, 212 and 213, and includes a row of three upper modules 220 supported on and above respective base portions 211 to 213 to define respective toasting stations each having a toasting space for receiving and toasting a pizza bread 10. One said temperature sensor 400, which may be implemented by a thermal couple, is provided at each base portion 211/212/213 for sensing or monitoring the temperature associated with the corresponding toasting space.

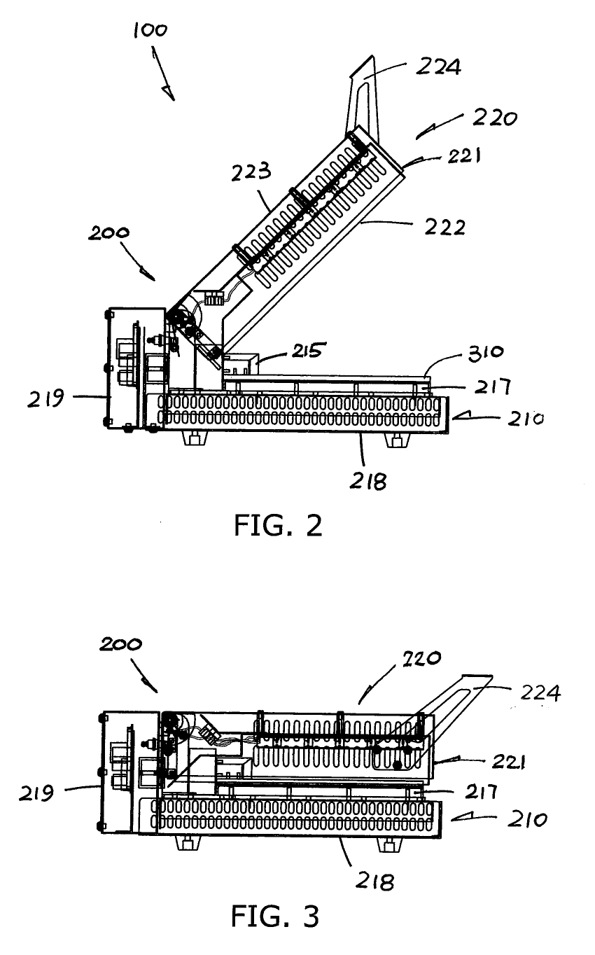

The upper modules 220 have the same general construction, each being supported for movement between a toasting position (FIG. 3) in which the upper module 220 is closed upon the base portion 211/212/213, together defining a respective toasting space, and a non-toasting position (FIG. 2) in which the upper module 220 is opened from the base portion 211/212/213.

The base 210 has a flat rectangular horizontal main housing 218 and an upstanding rectangular power unit housing 219 extending along the back. The power unit housing 219 houses a power unit for powering the heaters 300. On the main housing 218 at positions corresponding to the base portions 211/212/213, there are three flat rectangular platforms 217 in alignment with the respective upper modules 220. An (first) electrical heating element or heater 310 is located flat on and matching with the top of each platform 217. These heaters 310 are preferably electrical wire heaters, each being rated at 450 W operating power.

The upper modules 220 are each pivotably connected to near the top of the power unit housing 219 by means of a horizontal hinge shaft 21 such that the upper module 220 is pivotable down to lie horizontally in the toasting position and up to be inclined upwards at about 45° in the non-toasting position. The shaft 21 has a hexagonal cross-section and is rotatably mounted on and extending across a pair of left and right sheave units 22 mounted on the power unit housing 219. A pair of elbow springs 23 disposed on opposite ends of the shaft 21, acting between the upper module 220 and the power unit housing 219 to resiliently bias the upper module 220 upwards towards the non-toasting position.

Each upper module 220 has an oblong box-like housing 221 which is mounted fast, at its rear end, about the shaft 21 for angular movement therewith. The housing 221 has solid walls and an open bottom side defining a skirt 222, such that the housing 221 is capable of trapping hot air by reason of its open-bottom box-like structure. By trapping hot air in a toasting operation, each toasting station of the toasting apparatus 100 is able to make fullest possible use of the heat generated by the heaters 300.

The skirt 222 is in alignment with the corresponding platform 217, which has a matching shape but a slightly smaller size relative to the skirt 222. In the toasting position, the skirt 222 closes upon the base 210 and surrounds the platform 217 to define and in particular to enclose the toasting space, with the skirt 222 delineating the periphery of the toasting space.

Inside each upper module 220, the toasting space is provided with at least one and preferably two guides at opposite ends of the toasting space for guiding and positioning a pizza bread 10 in the toasting space by locating opposite ends of the spit 11 that supports the pizza bread 10. In general, each guide has a recess or slot for receiving and locating a respective end of the spit 11. The first guide is provided by a self-guiding block 215 located centrally at the rear end of the platform 217 on the base 210, which has a shallow V-shaped recess with a bottom that splits into a vertical central slot 216. The second guide is implemented by an inverted V-shaped cutout 225 cut centrally through the front wall of the housing 221 of the upper module 220, facing downwardly to engage and locate the front end of the spit 11 from above instead.

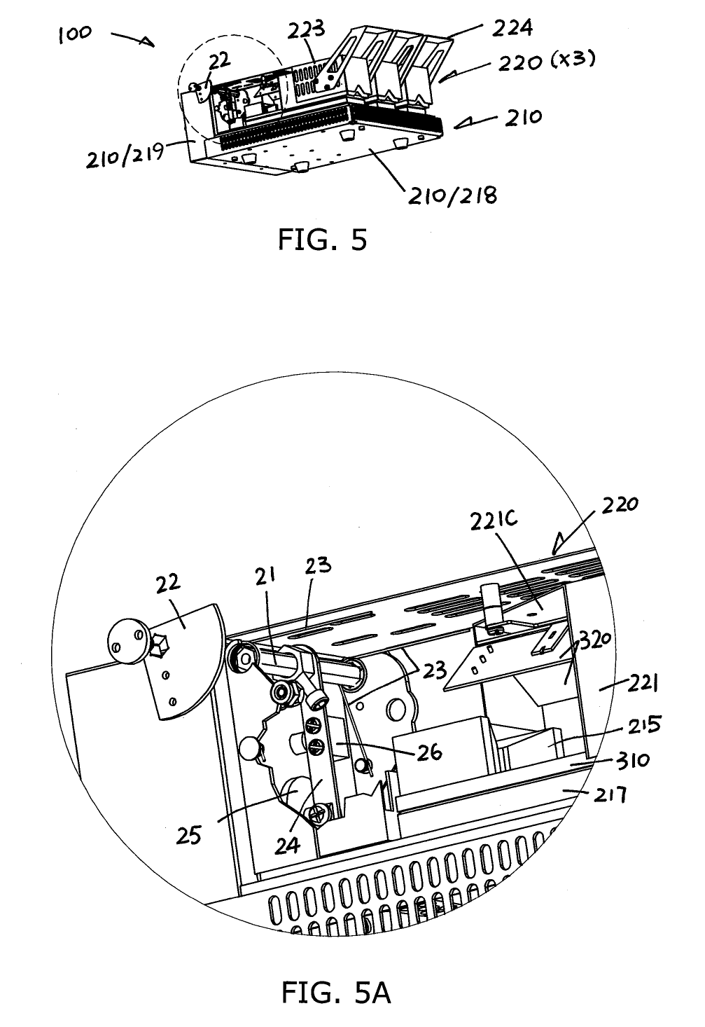

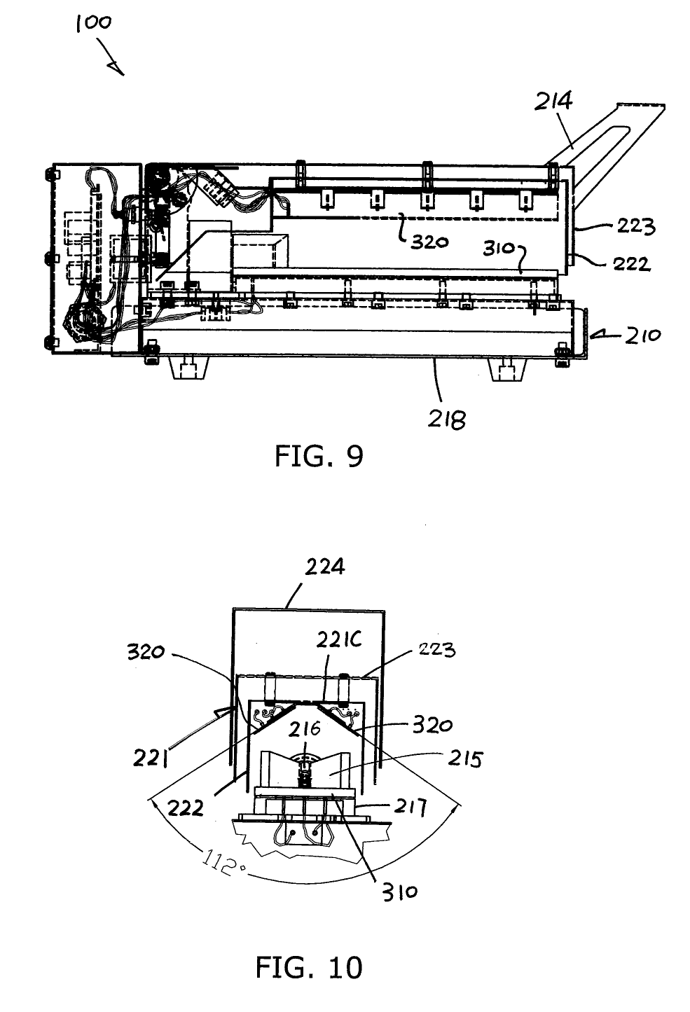

Each upper module 220 includes an (second) electrical heating element or heater 320 in duplicate, which are provided on or within opposite left and right sides of a ceiling 221C of the upper module housing 221. The two heaters 320 are spaced apart as between opposite left and right sides of the ceiling 221C and are located to face inwards at an acute angle (see FIGS. 5A and 9). These electrical heaters 320 are preferably infrared heaters for non-contact heating, each being rated at 300 W operating power.

The upper module housings 221 will get very hot in use and are each protected by a respective apertured or latticed cover or screen 223 of the same shape but a slightly larger size. Each upper module 220 includes at its free end a handle 224 to facilitate manual pivoting of the upper module 220 between the toasting and non-toasting positions.

Inside the housing 221 of each upper module 220, a lever 24 is connected with its rear end to the shaft 21 and projects from the shaft 21 generally downwardly at right angles to the longitudinal extent of the housing 221. The arrangement is such that when the upper module 220 is in the horizontal toasting position, the lever extends vertically downwards and immediately in front of the power unit housing 219.

The lever 24 has, at its free end, a soft-iron disc 25 and, at about mid-length, a press plate 26 on the right side. The disc 25 is co-operable with an aligned electro-magnetic solenoid catch 27 of the control circuit 500, located on the power unit housing 219, for magnetic attachment by the catch 27 to hold the upper module 220 in the toasting position against the action of the springs 23. The press plate 26 is co-operable with an aligned electrical switch 28 located on the power unit housing 219, which includes an operating member in the form of a pushbutton arranged for pressing to close the electrical switch 28 to turn on the control circuit 500 upon the upper module 220 being pivoted to reach the toasting position.

Under the action of the springs 23 holding it in the non-toasting position, the upper module 220 reveals the associated toasting space, into which a pizza bread 10 is inserted for toasting. The pizza bread 10 may easily be located centrally as between left and right on the platform 217 initially by the self-guiding block 215 engaging the far (upper) end of the spit 11 and then, upon pivoting of the upper module 220 down to the toasting position, by the inverted V-shaped cutout 225 of the upper module 220 engaging the near (lower) end of the spit 11.

In operation, the control circuit 500 is turned on once the upper module 220 is pressed down manually by a user to reach the toasting position, whereupon the electrical switch 28 is closed to turn on the control circuit 500 for toasting a pizza bread 10 now received and fully enclosed in the toasting space. The control circuit 500 instantly enables energization of the solenoid catch 27 to hold the upper module 220 down in the toasting position and will, upon termination of the toasting operation, de-energize the solenoid catch 27 to release the upper module 220 for pivoting up from the toasting position to the non-toasting position by the springs 23. The electrical switch 28 is opened in response to the upper module 220 departing from the toasting position, thereby turning off the control circuit 500 and hence terminating the toasting operation.

While it is in operation and at a preprogrammed time (the time is temperature dependent) the control circuit 500 enables energization of the lower heater 310 provided at the base portion 211/212/213 in use to toast the lower side of the pizza bread 10 and energization of the upper heaters 320 provided at the associated upper module 220 to toast the upper side of the pizza bread 10.

The pizza bread 10 is prepared in and/or cut to a specific shape and size that fit on the platform 217 and within the toasting space. The pizza bread 10 is a relatively small piece of food (compared to a regular or full-sized pizza) and it is located inside the toasting space in a close fit for speedy and even toasting. Such a toasting condition requires that the toasting temperature be controlled accurately in order to achieve optimal toasting. Due to its relatively small size and close fit inside the toasting space, the pizza bread 10 is particularly prone to overcooking or charring. The control circuit 500 is programmed to solve this problem.

The control circuit 500 controls the operation of all three heaters 310/320 by varying their operating times in one or more cycles as between different levels of operating power, such as full-load current and zero current in this particular embodiment, for optimum toasting temperature control. More specifically, the control circuit 500 switches on and switches off the heaters 310/320 once (or repeatedly) during each toasting operation by controlling the mark-to-space ratio in terms of operation of the heaters 310/320 as between operation (i.e. being turned on) and non-operation (i.e. being turned off). That is to say, the control circuit 500 controls by adjusting the duty cycle, i.e. the relative time of or between turning on and turning off, of the heaters 310/320.

In this particular embodiment, the control circuit 500 controls the operation of the heaters 310/320 by initially not turning on and subsequently upon elapsing of a certain time interval turning on the heaters 310/320, or in other words by delaying turning on of the heaters 310/320 by a certain time interval. The time interval is automatically determined by the control circuit 500 based on the toasting space's initial temperature in a direct relationship (i.e. as one variable increases, so does the other), which is a generally linear relationship.

Although in described embodiment the control circuit 500 is programmed to turn on and turn off the heaters 310/320 in one duty cycle during each toasting operation, it is envisaged that the heaters 310/320 may be turned on and off in more than one duty cycle or a plurality of duty cycles during each toasting operation according to another toasting program.

The temperature of the toasting space in use immediately prior to the commencement of a toasting operation is an important factor to achieve optimum toasting results. This initial temperature may be the room temperature if the toasting apparatus 100 has not been used or left for a while, or it may be a higher temperature maintained by residue heat from the last toasting operation, which is higher the shorter the time it is from the last toasting operation.

The present toasting apparatus 100 is designed to cater for a toasting temperature in the range from 0° C., which is a chosen lowest ambient temperature before toasting starts, to 300° C., which is the maximum temperature achievable by the heaters 310/320. The aforesaid initial temperature also falls within the same range, as it corresponds to the toasting temperature upon or subsequent to termination of toasting. The temperature is measured or monitored by the temperature sensor 400 for each toasting station.

The aforesaid control of heater duty cycle is implemented by turning on and off the heaters 310/320 according to an algorithm or scheme which is dependent on, or referencing, the initial temperature associated with the toasting space as measured by the temperature sensor 400 immediately prior to the commencement of each toasting operation. More specifically, the control scheme is temperature-dependent and is derived based on an inverse relationship with respect to the initial toasting space temperature. Due to the difference in nature between the upper and lower sides of the pizza bread 10, the inverse relationship is different as between the upper heaters 320 in the upper module 210 and the lower heater 310 in the base 210.

The toasting time, which is more specifically the time during which the pizza bread 10 stays enclosed, and being toasted, inside the toasting space, i.e. the upper module 200 staying closed in the toasting position, is another important factor that determines the quality, which is primarily crispiness, of the toasted pizza bread 10. The toasting time corresponds to the times of turning on and turning off of the heaters 310/320 during each toasting operation, which add up to a total period of time that should be practically constant, i.e. independent of the aforesaid initial temperature of the toasting space. Crispiness, in particular, takes a certain length of time to achieve.

In this particular embodiment, it has been determined that the pizza bread 10 should stay inside the toasting station/apparatus 100, while being toasted with the heaters 310/320 turning on and off, for an optimal period of toasting time of about 150 seconds. Pre-production experiments determine that the total time of turning on and off of the heaters 310/320 during each toasting operation, which corresponds to the duration of the relevant upper module 220 staying in the toasting position, may in general vary within plus or minus 10% variation about an optimal period, which is 150 seconds, over the range of predetermined toasting temperature (which corresponds to the aforesaid initial temperature of the toasting space immediately prior to toasting).

For each toasting operation of the present toasting apparatus 100, the total time of turning on and off of the heaters 310/320, or the toasting position duration for the upper modules 220, ranges from 142 seconds to 150 seconds (142 seconds being 150 seconds less 5%).

The table below shows the relationship of the heater duty cycle in terms of the duration when the heaters 310/320 are turned ON and OFF and the duration of the toasting position versus the measurement of the temperature sensor 400 (i.e. the initial temperature associated with the toasting space immediately prior to the commencement of each toasting operation).

| Temperature T | Heater Duty Cycle | | | | |
|---|---|---|---|---|---|
| measured by | Upper Heaters | | Lower Heater | | |
| Temperature | 320 | | 310 | | Toasting |
| Sensor 400 | OFF | ON | OFF | ON | Position |
| 0° C.-60° C. | 0 sec | 150 sec | 0 sec | 150 sec | 150 sec |
| 60° C.-80° C. | 15 sec | 135 sec | 15 sec | 135 sec | 150 sec |
| 80° C.-100° C. | 15 sec | 135 sec | 30 sec | 120 sec | 150 sec |
| 100° C.-140° C. | 30 sec | 120 sec | 60 sec | 90 sec | 150 sec |
| 140° C.-180° C. | 45 sec | 105 sec | 90 sec | 60 sec | 150 sec |
| 180° C.-220° C. | 55 sec | 90 sec | 115 sec | 30 sec | 145 sec |
| 220° C.-270° C. | 67 sec | 75 sec | 127 sec | 15 sec | 142 sec |

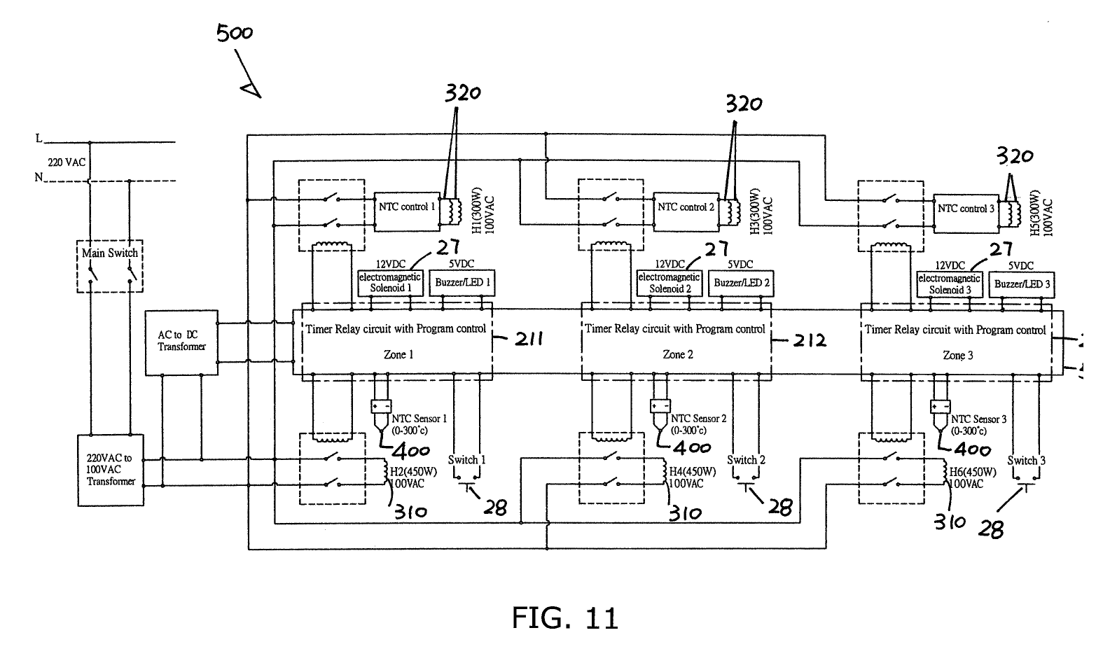

FIG. 11 is a graph showing the relationship between the turned ON duration of the heaters 310/320, which is expressed as a percentage of the heaters' turned ON duration over the toasting position duration, versus the initial temperature measured by the temperature sensor 400. As is shown in this graph, the time of turning ON of the heaters 310/320 is determined by the control circuit 500 based on the toasting space's initial temperature in an inverse relationship, which is a generally linear relationship as represented by a straight trend line 310N for the lower heater 310 and a straight trend line 320N for the upper heaters 320.

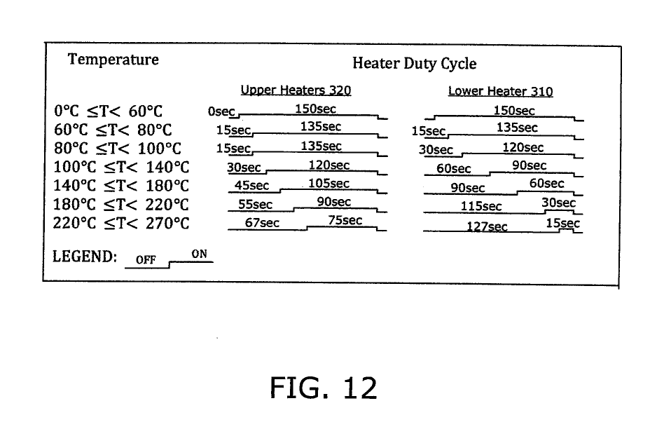

FIG. 12 is a graph showing the relationship between the turned OFF duration of the heaters 310/320, which is expressed as a percentage of the heaters' turned OFF duration over the toasting position duration, versus the initial temperature measured by the temperature sensor 400. As is shown in this graph, the time of turning OFF of the heaters 310/320 is determined by the control circuit 500 based on the toasting space's initial temperature in an inverse relationship, which is a generally linear relationship as represented by a straight trend line 310F for the lower heater 310 and a straight trend line 320F for the upper heaters 320.

According to both graphs, the trend lines 310N and 310F for the lower heater 310 have a larger gradient than that of the trend lines 320N and 320F for the upper heaters 320, i.e. the aforesaid inverse relationship with respect to the toasting space's initial temperature for the lower heater 310 and that for the upper heaters 320 are different. Accordingly, in general the upper heaters 320 are turned ON for relatively longer time than the lower heater 310, or conversely the upper heaters 320 are turned OFF for relatively shorter time than the lower heater 310.

The toasting apparatus of the present invention are particularly suitable for use in a commercial establishment, such as a restaurant or food shop, where the food concerned is toasted or prepared on a regular basis or frequent demand.

The invention has been given by way of example only, and various other modifications of and/or alterations to the described embodiment may be made by persons skilled in the art without departing from the scope of the invention as specified in the appended claims.

1. A toasting apparatus comprising:
a body having a toasting space for receiving an item of food to be toasted;
at least one electrical heating element associated with the body for toasting the item of food;
a temperature sensor for sensing temperature associated with the toasting space and providing an output signal indicative of the temperature sensed;
a control circuit for controlling operation of the at least one electrical heating element in a toasting operation by reference to the output signal of the temperature sensor and corresponding to an initial temperature associated with the toasting space, immediately prior to commencement of the toasting operation; wherein the control circuit controls the at least one electrical heating element by varying at least one of operating power supplied to the at least one electrical heating element and operating time of the at least one electrical heating element during each toasting operation, in an inverse relationship to the initial temperature.

2. The toasting apparatus as claimed in claim 1, wherein the control circuit controls the at least one electrical heating element by varying the operating time of the at least one electrical heating element.

3. The toasting apparatus as claimed in claim 2, wherein the control circuit controls the at least one electrical heating element by varying a mark-to-space ratio in operation of the at least one electrical heating element.

4. The toasting apparatus as claimed in claim 1, wherein the control circuit controls the at least one electrical heating element by varying relative duration of turning on and turning off the at least one electrical heating element.

5. The toasting apparatus as claimed in claim 4, wherein the relative duration of turning on of the at least one electrical heating element is determined by the control circuit based on the initial temperature, in an inverse relationship.

6. The toasting apparatus as claimed in claim 4, wherein
the control circuit controls the at least one electrical heating element by initially not turning on and, subsequently, upon elapsing of a time interval, turning on the at least one electrical heating element, and
the time interval is determined by the control circuit based on the initial temperature, in a direct relationship.

7. The toasting apparatus as claimed in claim 4, wherein the control circuit the at least one electrical heating element by delaying turning on the at least one electrical heating element by a time interval which is determined by the control circuit based on the initial temperature, in a direct relationship.

8. The toasting apparatus as claimed in claim 5, wherein the relationship comprises a generally linear relationship.

9. The toasting apparatus as claimed in claim 4, wherein the control circuit turns on and turns off the at least one electrical heating element in one or more cycles during each toasting operation.

10. The toasting apparatus as claimed in claim 4, wherein times of turning on and turning off of the at least one electrical heating element during each toasting operation add up to a total period of time which is practically constant over a possible range of initial temperatures.

11. The toasting apparatus as claimed in claim 4, wherein times of turning on and turning off of the at least one electrical heating element during each toasting operation add up to a total time period which falls within a predetermined range, within a 10% plus-or-minus variation over a possible range of initial temperatures.

12. The toasting apparatus as claimed in claim 1, wherein
the body comprises a base and an upper module located on or above the base and supported for movement between a toasting position, in which the upper module is closed upon the base, together defining the toasting space, and a non-toasting position, in which the upper module is opened from the base, and
a first electrical heating element is located at the base for toasting a lower side of the item of food,
a second electrical heating element is located at the upper module for toasting an upper side of the item of food, and
the temperature sensor is located at the base.

13. The toasting apparatus as claimed in claim 12, wherein the control circuit controls the operation of both of the first and the second electrical heating elements.

14. The toasting apparatus as claimed in claim 13, wherein the control circuit controls operation of the first and second electrical heating elements in respective and different inverse relationships to the initial temperature.

15. The toasting apparatus as claimed in claim 12, wherein the second electrical heating element comprises an infrared heating element.

16. The toasting apparatus as claimed in claim 12, wherein the upper module includes two second electrical heating elements, which are located on or within opposite left and right sides of a ceiling of the upper module.

17. The toasting apparatus as claimed in claim 16, wherein the two second electrical heating elements are spaced apart, on opposite left and right sides of the ceiling, and are face inwards at an acute angle.

18. The toasting apparatus as claimed in claim 12, wherein the control circuit commences each toasting operation upon movement of the upper module to the toasting position, and terminates each toasting operation with movement of the upper module from the toasting position.

19. The toasting apparatus as claimed in claim 18, wherein the control circuit includes an electrical switch having an operating member which is arranged for movement to close the electrical switch to commence each toasting operation, in response to the upper module reaching the toasting position, and for movement to open the electrical switch to terminate the toasting operation, in response to the upper module departing from the toasting position.

20. The toasting apparatus as claimed in claim 19, wherein
the upper module is resiliently biased towards the non-toasting position, and
the control circuit includes an electromagnetic catch for holding the upper module in the toasting position during each toasting operation, and for releasing the upper module from the toasting position upon termination of the toasting operation.

21. The toasting apparatus as claimed in claim 12, wherein the upper module has a housing with a skirt which, in the toasting position, closes upon the base and defines a periphery of the toasting space.

22. The toasting apparatus as claimed in claim 21, wherein
the housing of the upper module has solid walls and an open bottom side defining the skirt, and
the housing traps hot air.

23. The toasting apparatus as claimed in claim 21, wherein the base includes a platform having a shape matching in shape and smaller in size than the skirt and, in the toasting position, at least partially surrounded by the skirt.

24. The toasting apparatus as claimed in claim 1, wherein the toasting space includes at least one guide for guiding and positioning the item of food in the toasting space.

25. The toasting apparatus as claimed in claim 12, wherein
the toasting space includes at least one guide for guiding and positioning the item of food in the toasting space, and
the at least one guide comprises a recess for receiving and positioning an elongate member holding the item of food.

26. The toasting apparatus as claimed in claim 25, wherein said at least one guide comprises two recesses at opposite ends of the toasting space for receiving and positioning respective opposite ends of the elongate member holding the item of food.

27. The toasting apparatus as claimed in claim 26, wherein one of the two recesses is located centrally on the base and the other of the two recesses is located centrally on the upper module.

28. The toasting apparatus as claimed in claim 12, wherein
the body comprises the base and a plurality of upper modules, and
each upper modules includes a respective second electrical heating element and is located on or above a respective base portion of the base and defines a respective toasting space, with each base portion including a respective first electrical heating element.
